(19) United States
(12) Patent Application Publication
(10) Pub. No.: US 2024/0191743 A1
(43) Pub. Date: Jun. 13, 2024

(54) Assembly Part, Method of Assembling an Assembly Part, and Fastening Insert

(71) Applicant: Connecteurs Electriques Deutsch, Evreux (FR)

(72) Inventors: Frederic Duval, Evreux (FR); Fabien Houvenaghel, Evreux (FR)

(73) Assignee: Connecteurs Electriques Deutsch, Evreux (FR)

(21) Appl. No.: 18/537,159

(22) Filed: Dec. 12, 2023

(30) Foreign Application Priority Data
Dec. 12, 2022 (EP) 22306851.1

(51) Int. Cl. F16B 37/04; F16B 11/00

(52) U.S. Cl. CPC F16B 37/045; F16B 11/00

(57) ABSTRACT

An assembly part configured to be fastened to a counterpart includes a body traversed by a traversing hole and a fastening insert configured to receive a fastening device in a hollow of the fastening insert along a first direction to fasten the assembly part to the counterpart. The fastening insert has a proximal end portion and a distal end portion in the first direction. The fastening insert is positioned in the traversing hole. A movement of the fastening insert in a second direction opposite to the first direction is blocked by a first form fit between the distal end portion and the body, and a movement of the fastening insert in the first direction is blocked by a second form fit between the proximal end portion and the body.

### CROSS-REFERENCE TO RELATED APPLICATIONS

This application claims the benefit of the filing date under 35 U.S.C. § 119(a)-(d) of European Patent Application No. 22306851.1, filed on Dec. 12, 2022.

### FIELD OF THE INVENTION

The present invention relates to an assembly part configured to be fastened to a counterpart, to a method of assembling an assembly part, and to a method of fastening the assembly part to a counterpart. The present invention further relates to a fastening insert suitable for the assembly part.

### BACKGROUND

It is known in the art to fasten an assembly part to a counterpart by using a screw or the like, in conjunction with a threaded fastening insert present in the assembly part. For this purpose, the fastening insert of the assembly part is aligned with a through hole in a counterpart. To fasten the parts, the screw is passed through the through hole of the counterpart and fixed by the thread of the fastening insert of the assembly part.

A typical assembly part known in the art will be described with reference to FIGS. 1A and 1B. FIG. 1A shows a cross-sectional view of prior art fastening inserts P1a, P1b before their assembly with an exemplary body P101 of an assembly part P100. The body P101 is provided with two traversing holes P103a, P103b. The two fastening inserts P1a, P1b are positioned facing the traversing holes P103a, P103b, but are not yet inserted. Each one of the holes P103a, P103b has, in respective secondary directions PSa, PSb, a conical primary section P105a, P105b, a narrowed ledge section P107a, P107b, and a chamfered opening section P109a, P109b.

The traversing holes P103a, P103b formed in the body P101 have opposed respective secondary directions PSa, PSb and differing lengths. The fastening inserts P1a, P1b have a conical shape, as known for example from Morse-type machine tapers, matching the primary conical sections P105a, P105b. The fastening inserts P1a, P1b are configured as nuts for corresponding bolts P200a, P200b, shown in FIG. 1B, and thus comprise an internal thread P3a, P3b.

FIG. 1B shows the cross-sectional view of FIG. 1A, in which the assembly part P100 is assembled and fastened to a first counterpart P300 and to a second counterpart P400. Specifically, the fastening inserts P1a, P1b have been inserted in the corresponding traversing holes P103a, P103b along their respective secondary directions PSa, PSb, into the primary conical sections P105a, P105b until they are blocked by the narrowed sections P107a, P107b, obtaining an assembly part P100 ready to be fastened. Subsequently, the first counterpart P300 and the second counterpart P400 have each, separately, been fastened to the assembly part P100 by respective bolts P200a, P200b passed through the through holes P301, P401 and screwed in respective primary directions PFa, PFb opposed to the secondary directions PSa, PSb.

To obtain the assembly part P100, the dimensions of the fastening inserts P1a, P1b are selected to achieve a friction fit that firmly holds the fastening inserts P1a, P1b in the traversing holes P103a, P103b. Thus, on the one hand, if the fastening inserts P1a, P1b are dimensioned too small, they risk falling back out of the holes P103a, P103b in the primary directions PFa, PFb. On the other hand, if the fastening inserts P1a, P1b are too large, they risk being damaged or damaging the body P3 during insertion, or risk not being correctly insertable in the traversing holes P105a, P105b. It appears, however, that due to manufacturing tolerances or the use of varying production processes, the outlined dimensional requirements of the various parts cannot be guaranteed, leading to problems during assembly.

### SUMMARY

An assembly part configured to be fastened to a counterpart includes a body traversed by a traversing hole and a fastening insert configured to receive a fastening device in a hollow of the fastening insert along a first direction to fasten the assembly part to the counterpart. The fastening insert has a proximal end portion and a distal end portion in the first direction. The fastening insert is positioned in the traversing hole. A movement of the fastening insert in a second direction opposite to the first direction is blocked by a first form fit between the distal end portion and the body, and a movement of the fastening insert in the first direction is blocked by a second form fit between the proximal end portion and the body.

### BRIEF DESCRIPTION OF THE DRAWINGS

The invention will now be described by way of example with reference to the accompanying Figures, of which:

FIG. 1A shows a cross-sectional view of a body and two fastening inserts of an assembly part known from prior art, before their assembly;

FIG. 1B shows a cross-sectional view of the fastening inserts and the body of the assembly part known from prior art, assembled and fastened a counterpart;

FIG. 2 shows a perspective view of a fastening insert according to an embodiment of the invention;

FIG. 3A shows a cross-sectional view of an assembly part, in a first stage of an embodiment of a method of assembly according to the invention;

FIG. 3B shows the view of FIG. 3A in a second stage of the method;

FIG. 3C shows a cross-sectional view of the assembly part in a third stage of the method;

FIG. 3D shows the view of FIG. 3C in a fourth stage of the method;

FIG. 3E shows the view of FIG. 3C in a fifth stage of the method;

FIG. 4 illustrates the assembled assembly part with a mating fastening device, before a fastening;

FIG. 5A shows a cross-sectional view of an assembly part according to an embodiment of the invention, fastened to a counterpart; and

FIG. 5B shows top plane view of the fastened assembly part of FIG. 5A.

### DETAILED DESCRIPTION OF THE EMBODIMENT(S)

The invention will be more completely understood and appreciated by careful study of the following more detailed description of exemplary aspects and embodiments of the invention, taken in conjunction with accompanying drawings.

In the following descriptive part, identical reference numerals in the text and in the figures refer to identical elements, of which the repeated descriptions will be avoided as a matter of convenience.

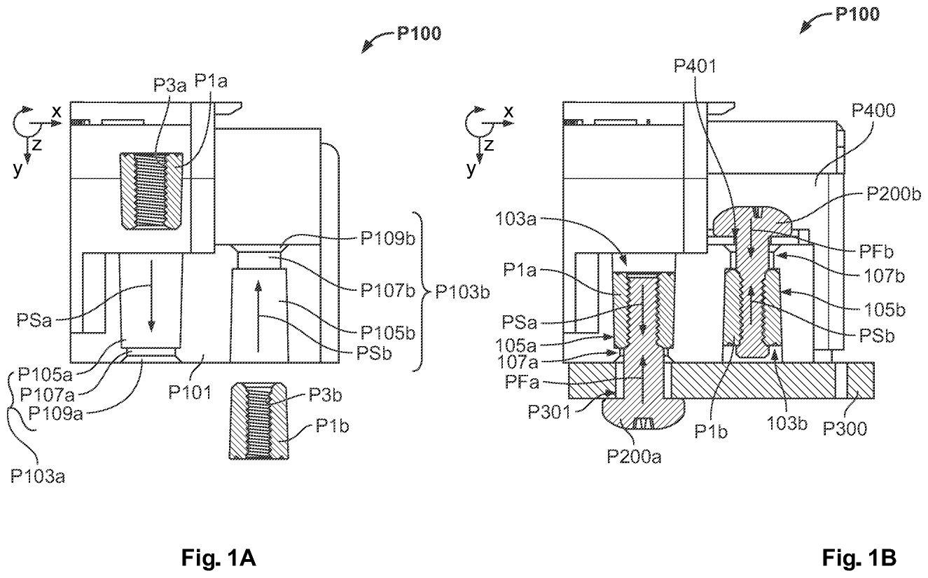

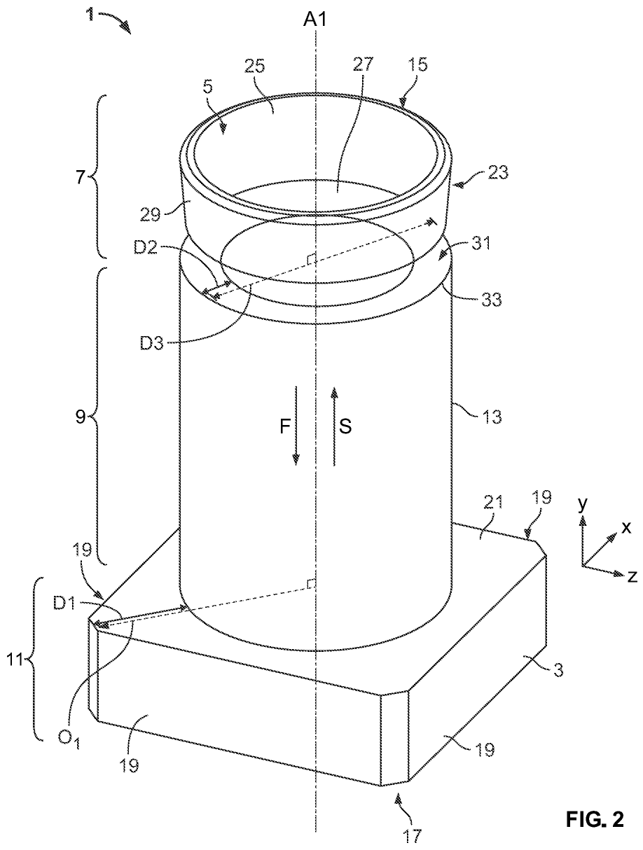

An assembly part, a fastening insert and method for assembling the assembly part and for fastening the assembly part to a counterpart according to prior art have already been outlined in the background section, with reference to FIGS. 1A and 1B. A fastening insert according to an embodiment of the invention will now be described with reference to FIG. 2. FIG. 2 shows a perspective view of the fastening insert 1.

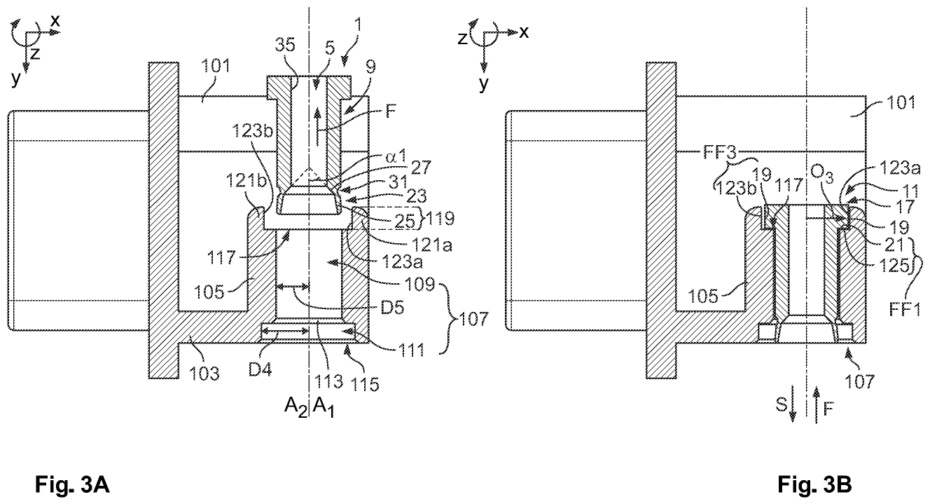

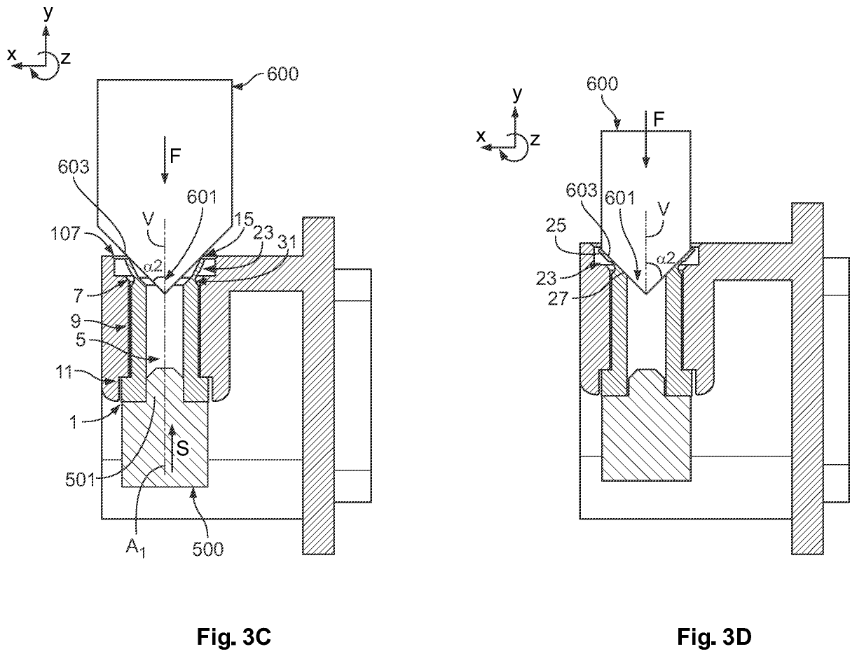

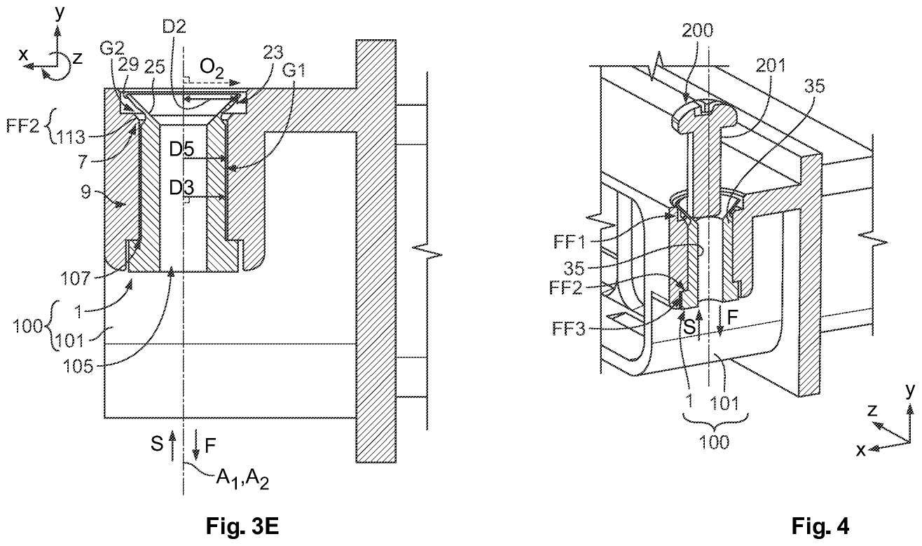

The fastening insert 1 of FIG. 2 is suitable for an assembly part according to the invention, for example the assembly part described in the following, with reference to FIGS. 3A-5B. The fastening insert 1 is also suitable for a method of assembling an assembly part according to the invention, and for a method of fastening an assembly part to a counterpart according to the invention, for example the methods described in the following with reference to FIGS. 3A-3E, 4, 5A and 5B.

In the present embodiment, the fastening insert 1 is formed in a single, monolithic, piece. In an embodiment, the fastening insert 1 is machined in brass. However, in other embodiments, the fastening insert 1 is instead formed out of stainless steel, or out of aluminum. In an embodiment, at least the proximal end portion of the fastening insert 1 can be formed of metal suitable for plastic deformation, such as stainless steel, brass, or an aluminum alloy. In an embodiment, the metal is also resistant to corrosion and suitable for machining.

The monolithic insert body 3 of the fastening insert 1 extends along a first direction F and is hollow. In particular, the insert body 3 of the fastening insert 1 defines a hollow 5. The hollow 5 extends along the first direction F through the fastening insert 1, and defines a center axis A1 parallel to the first direction F and to a Cartesian direction y.

The insert body 3 comprises, in the first direction F, a proximal end portion 7, a middle portion 9, and a distal end portion 11. The proximal end portion 7, the middle portion 9, and the distal end portion 11 constitute together the monolithic insert body 3.

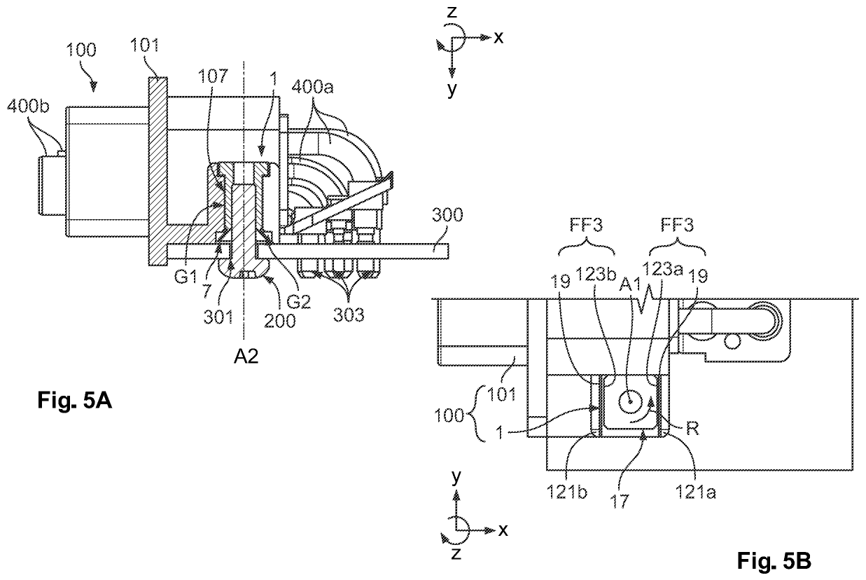

The fastening insert 1 is a nut configured to receive the bolt 200 according to the example shown in FIGS. 4, 5A and 5B, in the hollow 3 along the first direction F. In an embodiment, the middle portion 9 is tubular, having a cylindrical external surface 13 and a threaded internal surface surrounding a cylindrical portion of the hollow 5. The internal thread of the middle portion 9 is configured to couple with a matching thread 201 of the bolt 200 inserted in the first direction F in the hollow via a circular opening 15 in the proximal end portion 7 of the insert body 3. The opening 15 faces in the second direction S opposed to the first direction F.

The distal end portion 11 comprises a ledge portion 17, as shown in FIG. 2. The ledge portion 17 has a cuboid shape that protrudes outwardly with respect to the cylindrical external surface 13 of the middle portion 9, in all directions orthogonal to the first direction F, extending beyond the cross-section of the middle portion 9. For example, the ledge portion 17 extends in a first orthogonal direction O₁ orthogonal to the first direction F, extending beyond the cross-section of the middle portion 9. That is, the ledge portion 17 extends beyond the circular cross-section of the middle portion 9 projected onto the plane of the first orthogonal direction O₁, by the distance D1. The cuboid shape of the ledge portion 17 provides four plane, equivalently sized, edge surfaces 19, parallel to the first direction F, and one interfacial surface 21 facing in the second direction S and linking the edge surfaces 19 to the external surface 13 of the middle portion 9.

The proximal end portion 7 comprises a deformation portion 23, formed at the extremity facing in the second direction S. In this embodiment, the deformation portion 23 is bowl-shaped, the bowl shape having the center axis A1 as bowl center axis. The bowl is formed so as to open outwardly in the second direction S, such that the opening of the bowl shape corresponds to the opening 15 of the proximal end portion 7 of the fastening insert 1. In variants of the fastening insert, the deformation portion 23 can, instead of the bowl shape, be arranged in the same way but be formed in the shape of a hollow hemi-ellipsoid, or in the shape of a tulip flower, or in the shape of a barrel.

The bowl-shaped deformation portion 23 has an internal surface 25 surrounding an at least partly bowl-shaped portion of the hollow 5. FIG. 2 also shows a conical sub-portion 27 of the internal surface 25 that will be further described with reference to FIGS. 3A and 3B. The bowl-shaped deformation portion 23 has an external surface 29 that is flush aligned with respect to the external surface 13 of the middle portion 9.

The proximal end portion 7 further comprises a circumferential groove 31, shown in FIG. 2, formed externally on the body 3 of the fastening insert 1, in particular along or adjacent to the external surface 29 of the deformation portion 23. The groove 31 is formed in an area corresponding to the border between the deformation portion 23, or the proximal end portion 7, and the middle portion 9. The groove 31 extends externally in a plane orthogonal to the first direction F and partially defines the bottom of the bowl shape of the deformation portion 23.

The circumferential groove 31 has a depth D2 between 1% and 20%, in an embodiment between 3% and 10%, of the cross-sectional length D3 in a plane orthogonal to the first direction F of the fastening insert 1. For example, when cross-sectional length D3, that is, the diameter of the fastening insert 1 along the middle portion 9, has a length of 3.8 mm, the diameter of the fastening insert 1 inside the groove 31 can have a length of 3.5 mm, providing for a groove depth 0.15 mm, that is, of around 4%. Further, in the embodiment of FIG. 2, the groove 31 has a sharp edge 33, however, the groove 31 can also be chamfered or smooth-edged.

The groove 31 weakens the structure of the proximal end portion locally, in particular weakens the fastening insert 1 at the border of the deformation portion 23. Specifically, the groove 31 can focus or concentrate a mechanical force in a first direction on the outline of the groove 31, facilitate a deformation, such as a bending or a stretching of the fastening insert 1 material, at the groove. The deformation allows for an obtaining of the second form fit FF2 after the positioning of the fastening insert 1.

When the groove 31 extends along a border of the deformation portion 23, the deformation in the fastening insert 1 can be limited to only the deformation portion 23. Arranging the groove 31 in a plane orthogonal to the first direction F allows for a uniform deformation when a mechanical action, such as a punching of a punch press, is exerted in the first direction F.

A method for assembling an assembly part according to an embodiment of the invention will now be described with reference to FIGS. 3A to 3E. The assembly part 100 being assembled in the method described in the following comprises the fastening insert 1 of FIG. 2, and a body 101. FIGS. 3A to 3E show a cross-sectional view of the body 101 and the fastening insert 1 in successive stages of the method for assembling the assembly part 100.

In this example, the assembly part 100 is a connector housing of a modular power connector in a solid-state secondary power distribution (SSPC) system in an aircraft application. For this purpose, the assembly part 100 is configured to be fastened to a counterpart, for example to the printed circuit board 300 shown on FIGS. 5A and 5B, using the bolt 200, as shown on FIG. 4. For simplicity of illustration, the internal thread 35 of the fastening insert 1, as well as the corresponding thread 201 of the bolt 200, has been omitted from FIGS. 3A to 5B. In the present embodiment, the threads can be assumed to be identical to the threads P3a, P3b described with reference to FIG. 1B.

FIG. 3A shows the body 101 and the fastening insert 1 of FIG. 2 before a first step i) of the method for assembling the assembly part 100. The body 101 comprises a frame portion 103 extending in an x-z plane perpendicular to the first direction F, in which a projection 105 is formed projecting in the first direction F from the frame 103.

In this embodiment, the body 101 is made of metal-plated composite material. Specifically, the composite material of the body 101 is plated first with a copper layer, and second with a nickel layer. The copper under-layer allows for reduction of electromagnetic interference or parasitic effects between the interior and the exterior of the body 101 in the present application of a modular power connector. The nickel over-layer provides anti-corrosion and adherence benefits. As an example, the copper layer and the nickel layer can have a nominal thickness of 25 μm.

A traversing hole 107 is formed in the projection 105, with a traversing hole center axis A2 parallel to the first direction F. The traversing hole 107 comprises a cylindrical main section 109 and a cylindrical opening section 111, wherein the diameter D4 of the opening section 111 is larger than the diameter D5 of the main section 109. The cylindrical, in particular tubular, shape of the middle portion 9 allows for a rotationally symmetric insertion of the middle portion 9 in the traversing hole 107, facilitating the assembly. In an embodiment, the diameter D4 is between 10% and 70%, or in an embodiment between 30% and 50%, larger than the diameter D5. The surface 113 at the border between the main section 109 and the opening section 111 is chamfered.

The traversing hole 107 extends, in the first direction F, from a fastening opening 115, in sequence, through the opening section 111 and the main section 109, to an insertion opening 117. The projection 105 further comprises, adjacently and in proximity of the insertion opening 117, a mating portion 119 comprising two wall 121a, 121b. Each wall 121a, 121b is provided with one plane mating surface 123a, 123b, extending in parallel to the center axis A2 and the first direction F, and facing towards the center axis A2.

In FIG. 3A, the fastening insert 1 is not yet inserted in the traversing hole 107 and is instead outside of the body 101. The opening 15 of the fastening insert 1 faces the insertion opening 117 of the body 101. The center axis A1 of the fastening insert 1 is coaxial with the center axis A2 of the traversing hole 107.

In the cross-sectional view of FIG. 3A, the fastening insert 1 has the internal thread 35 at least along the middle portion 9, allowing the mating of the fastening insert 1 with a corresponding bolt 200. In addition, the cross-sectional view shows that the wall of the fastening insert 1 defining the hollow 5 is thinner in the deformation portion 23, in particular more than 50% and even 70% thinner, than the corresponding wall in the middle portion 9. For example, the wall of the fastening insert 1 defining the hollow 5 can have a thickness of 0.24 mm in the deformation portion 23 of 0.16 mm in the groove 31, and of 0.8 mm in the middle portion 9.

Further, the view of FIG. 3A shows the partially bowl-shaped internal surface 25 of the deformation portion 23. In particular, the internal surface 25 comprises the non-bowl-shaped internal surface sub-portion 27. The internal surface sub-portion 27 has the shape of a frustum of a right cone having a vertex centered on the hollow 5, that is on the center axis A1 of the fastening insert 1. In this embodiment, the internal surface sub-portion 27 has the shape of a frustum of a cone having an angle α1 of 45° with respect to the vertex, that is, the center axis A1.

In a first step i) of the method for assembling the assembly part 100, the fastening insert 1 is positioned in the traversing hole 107. Specifically, the fastening insert 1 is inserted in the traversing hole 107 through the insertion opening 117 along the second direction S. FIG. 3B shows the cross-sectional view of FIG. 3A after step i) is completed.

In this embodiment, the internal surface 25 of the deformation portion 23 is particularly suited to receive the movement of a press tool, such as a punch press, as it presses in the first direction F. In particular, it is suited to receive the tip of a punch press having a conical shape, in particular a 45° cone shape, and stop the movement of the punch press, at a desired location. For example, the internal surface having the shape of the cone frustum can be arranged at the border of the deformation portion 23, providing a stopping surface, for a moving pressing tool.

In addition, when the base diameter of the cone shape is larger than a base diameter of a traversing hole 107, the proximal end portion extends beyond the cross-section of the traversing hole, establishing the second form fit FF2. Thus, the conical shape can facilitate a second form fit in a smooth and circumferentially uniform manner.

The fastening insert 1 is inserted in the traversing hole 107 until the interfacial surface 21 abuts on a corresponding mating interfacial surface 125 of the projection 105, realizing a first form fit FF1 between the ledge portion 17 of the distal end portion 11 and the body 101. In other words, the extension of the ledge portion 17 beyond the cross-section of the traversing hole 107 in a direction orthogonal O₃ to the first direction blocks the fastening insert 1 from further movement in the second direction S. The ledge portion 19 can be formed to have thicker walls than the deformation portion 23.

In addition, the fastening insert 1 is inserted in the traversing hole 1077 such that shape of the ledge portion 19 matches the mating portion 119, establishing a further (also referred to herein as “third”) form fit FF3. Specifically, each plane mating surface 123a, 123b of the projection 105 faces or mates a corresponding plane edge surface 19. Thus, a rotational movement of the fastening insert 1 around the first direction F is blocked by the third form fit FF3 between the distal end portion 11 and the mating portion 119. For example, when the fastening device is an industrial screw or a bolt, and the fastening insert 1 is a corresponding nut, a stabilization of the fastening insert 1 with respect to the fastening device is required. The third form fit FF3 provides a reliable rotational stabilization without additional external devices.

The views of FIGS. 3C, 3D and 3E described in the following correspond to the view of FIGS. 3A and 3B, rotated by 180° around the Cartesian z-axis for convenience of illustration.

In a second step ii), a die 500 is pressed, or firmly held, against the distal end portion 11 of the fastening insert 1. This is represented schematically in FIG. 3C. The die 500 is pressed in the second direction S against the distal end portion 11 so as to stabilize and support the fastening insert 1 in its position in the traversing hole 107. To further strengthen the stabilizing function of the die 500, the die 500 comprises a die projection 501 inserted in the hollow 5 of the fastening insert, matching the shape of the hollow 5 in the distal end portion 11.

In a third step iii) the proximal end portion 7 is plastically deformed. In particular, a punch press 600 is mechanically pressed in the first direction F on the proximal end portion 7, causing a plastic deformation of said proximal end portion 7. The punch press 600 is represented schematically in FIG. 3C. The punch press 600 comprises a conical tip 601 having an angle α2 of 45° with respect to the cone vertex V of the punch press tip 601. The punch press 600 is centered on the hollow 5, that is, the cone vertex V is aligned on the center axis A1 of the bowl-shaped deformation portion 25.

FIG. 3C shows an intermediary stage during step iii), in which the punch press 600 has initiated its travel along first direction F. The punch press 600 is pressed along the first direction F and realizes a plastic deformation of the deformation portion 25. As the outer surface 603 of the conical tip 601 of the punch press 600 moves in the first direction F, it abuts on the deformation portion 23 at the opening 15, pressing it outwards. In this way, the opening 15 is increased in diameter and the bowl shape of the deformation portion 23 is opened and stretched along the outer surface 603 of the punch press 600. The circumferential groove 31 and the difference in thickness between deformation portion 11 and middle portion 9 amplify the efficiency, case, and precision of the plastic deformation.

FIG. 3D shows a stage of the method after step iii), in which the punch press 600 has reached the end of its travel range along the first direction F, and the plastic deformation of the deformation portion 23 is completed. The outer surface 603 of the cone tip 601 has abutted on the internal surface sub-portion 27 of the deformation portion 23, which has stopped the traveling of the punch press 600. At this stage, the entirety of the bowl-shaped part of the internal surface 25 is plastically deformed to match the conical shape of the cone tip 601 (see also FIG. 3E), specifically the right cone shape with a 45° angle with respect to the vertex V. The deformation portion 23 is stretched out along the outer surface 603 of the punch press 600. The diameter of the opening 15 is increased by at least 10% with respect to the diameter prior to the assembly method, as seen when comparing for example FIG. 3E and FIG. 2.

In variants of the above-described method, a stamping tool or a bending tool could also be used instead of a punching tool to realize the plastic deformation of step iii).

FIG. 3E shows a final state of the assembled assembly part 100 according to the invention, in which the punch press 600 and the die 500 are removed and the assembly part 100 is ready to be fastened to a counterpart. The deformation portion 23 is no longer bowl-shaped as shown in FIG. 2 and has instead been opened outwards from the hollow 105 to match a conical shape. In particular, the internal surface 25 of the deformation portion 23 has the shape of a frustum of a cone, specifically of the cone of the tip 601 of the punch press 600.

As can be seen on FIG. 3E, the deformation portion 23 now extends beyond the cross-section of the traversing hole 107. For example, the extension D6 in at least one direction O2 orthogonal to the second direction S is greater than the corresponding diameter D5 of the traversing hole 107. A movement in the first direction F of the fastening insert 1 is thus blocked by the abutment of the external surface 29 of the deformation portion 23 on the chamfered portion 113 of the body 101. The movement is thus blocked by a second form fit FF2 between the proximal end portion 7 and the body 101. In this way, the plastic deformation of step iii) has realized a form fit between the fastening insert 1 and the body 101 that blocks the fastening insert 1 both in the first direction F and in the opposing second direction.

FIG. 3E also shows that in this final state of assembly the external surface 29 of the deformation portion 25 does not directly abut on the chamfered surface portion 113, or any other portion of the body 101. Indeed, as described in the above, the movement of the punch press was not stopped by any part of the body 101, but by the body 3 of the fastening insert 1, in particular by the internal surface sub-portion 27 configured to arrest the punch press 600. Thus, a clearance gap G2 providing axial play along the fastening direction F is realized. The axial play of the clearance gap G2 allows for reduced strain on the insert 1 and the body 101 during handling and transportation, up until the assembly part 100 is fastened to a counterpart.

The middle portion 9 has a cross-sectional area, for example shown in relation to the cross-sectional length D3, at least 1%, in an embodiment between 2% and 10%, smaller than the cross-sectional area, for example shown in relation to the cross-sectional length D5, of the traversing hole 107, in a plane orthogonal to the first direction F. In other words, a clearance gap G1 remains between the external surface 13 of the middle portion 11 and the projection 105, allowing for small lateral movements orthogonally to the first direction F, which can be helpful when fastening the insert with a fastening device.

FIG. 4 shows a perspective of the cross-section represented on FIG. 3E, with a bolt 200 for illustration purposes outside of the insert 1, prior to insertion. The assembly part 100 is assembled, and the fastening insert 1 is fit to the body 101 by the first form fit FF1, the second form fit FF2, and the third form fit FF3, which have been described in the foregoing. In this state, the fastening insert 1 can be mated with the bolt 200 by screwing the bolt 200 in the hollow 5 in the first direction F, matching the internal thread 35 of the insert 1 and the thread 201 of the bolt 200.

A method of fastening an assembly part according to the invention to a counterpart will now be described with reference to FIG. 5A. FIG. 5A shows the assembled assembly part 100, with the fastening insert 1 described with reference to FIG. 2 and the body 101. In this example, the body 101 belonging to a connector housing has been wired with inlet wires 400a and outlet wires 400b. In addition, FIG. 5A shows the bolt 200 and a counterpart 300, here a printed circuit board (PCB), to which the inlet wires 400a have been connected at connection points 303.

In a first step, the assembly part 100 is assembled as specified in the assembly method described above. In a second step, the counterpart 300 is positioned in contact with the assembly part 100 such that a through hole 301 of the counterpart 300 is centered on the traversing hole 107 and faces the proximal end portion 7 of the fastening insert 1. That is, the through hole 301 is centered or centrally aligned on the center axis A2 of the traversing hole 107. In a third step, the bolt 200 is mated with, in particular screwed in, the fastening insert 1 through the through hole 301. In the fastened position, the radial play provided by the clearance gap G1, and the axial play provided by the clearance gap G2 are neutralized by the bolt 200, fastening the counterpart 300 to the assembly part 100.

It is noted that while the embodiments described with respect to the figures have related to the bolt 200 as fastening device, with the fastening insert 1 being a nut, other types of fastening systems are equally applicable. For example, key, pin, lock, screw, or frictional fastening systems for the mating of the fastening insert and the fastening device can be used and still benefit from the advantages of the invention.

In addition, while the thread 201 of the bolt 200 and the thread 35 of the fastening insert 1 are identical to the conventional threads of the inserts P1a, P1b and the bolts P200a, P200b illustrated in FIGS. 1A and 1B, in variants, the bolt 200 and insert 1 can also comprise alternative thread types. For example, they can be provided with alternative thread pitches, thread depths or thread leads. Further, the threads of the insert 1 and/or of the bolt 200 can comprise integrated self-locking tools or features.

FIG. 5B shows the arrangement of FIG. 5A in a top plane view, which illustrates the third form fit FF3 between the ledge portion 17 and the mating portion 119. FIG. 5B shows the assembly 100 comprising the body 101 and the fastening insert 1. The plane mating surfaces 123a, 123b of the walls 121a, 121b of the mating portion 119, and respective plane edge surface 19 of the ledge portion 17, face each other in close proximity. A rotational movement in the rotational direction R around the center axis A1 parallel to the fastening direction F is thus blocked.

In a thus configured assembly part, a movement of the fastening insert positioned in the traversing hole with respect to the body is blocked in two respectively opposing directions by respective form fits. Thus, the fastening insert is prevented from falling out from the hole and is securely attached to the body without resorting to a friction fit in the traversing hole. By providing the form fits in the end portions of the fastening insert, the fastening insert can be dimensioned so as to have sufficient clearance when positioned in the traversing hole, preventing damage when the fastening insert is inserted, both to the fastening insert and to the body defining the traversing hole.

As a corollary advantage, since the traversing hole is no longer required to have a precise structure enabling a friction fit, the manufacture of said hole is also simplified, increasing cost-efficiency of the assembly part.

In addition, as the first form fit and the second form fit only block movement along the two opposing directions, lateral movements, for example movements in directions orthogonal to the second direction, remain possible. Thus, in contrast to a friction fit solution such as the one described in the background section above, the present assembly part allows for additional centering, or adjusting, of the lateral positioning of the fastening insert in the traversing hole, with respect to a through hole in a counterpart. This can facilitate a mating of the fastening device and the fastening insert, for example the screwing of a screw or bolt in the fastening insert.

The described embodiment overcomes the restrictive manufacturing tolerance requirements mentioned in the background section and provides instead the advantages outlined in the description of the invention. In particular the technical advantages of the various implemented features are entered into effect in the present embodiment. The assembly part, the method of assembly of an assembly part, the method of fastening of an assembly part to a counterpart, and the fastening represent different aspects providing an improved fastening solution. The features of the various aspects, variants and embodiments of the invention described in the present specification can be freely combined with each other to obtain further embodiments or examples according to the invention.

What is claimed is:

1. An assembly part configured to be fastened to a counterpart, comprising:
a body traversed by a traversing hole; and
a fastening insert configured to receive a fastening device in a hollow of the fastening insert along a first direction to fasten the assembly part to the counterpart, the fastening insert has a proximal end portion and a distal end portion in the first direction, the fastening insert is positioned in the traversing hole, a movement of the fastening insert in a second direction opposite to the first direction is blocked by a first form fit between the distal end portion and the body, a movement of the fastening insert in the first direction is blocked by a second form fit between the proximal end portion and the body.

2. The assembly part of claim 1, wherein a rotational movement of the fastening insert around the first direction is blocked by a third form fit between the proximal end portion and/or the distal end portion and a mating portion of the body.

3. The assembly part of claim 1, wherein the distal end portion has a ledge portion extending beyond a cross-section of the traversing hole in at least one direction orthogonal to the first direction.

4. The assembly part of claim 3, wherein the ledge portion realizes the first form fit.

5. The assembly part of claim 1, wherein the proximal end portion has a circumferential groove along an external surface of the fastening insert.

6. The assembly part of claim 5, wherein the circumferential groove extends in a plane orthogonal to the first direction.

7. The assembly part of claim 5, wherein the proximal end portion has a deformation portion extending beyond a cross-section of the traversing hole in at least one direction orthogonal to the first direction.

8. The assembly part of claim 7, wherein the deformation portion realizes the second form fit.

9. The assembly part of claim 8, wherein a portion of an internal surface of the deformation portion has a shape of a frustum of a cone having a vertex centered on the hollow.

10. The assembly part of claim 9, wherein the shape of the frustum of the cone has a 45° angle with respect to the vertex.

11. A method of assembling an assembling part, comprising:
providing the assembly part including a body traversed by a traversing hole and a fastening insert configured to receive a fastening device in a hollow of the fastening insert along a first direction to fasten the assembly part to the counterpart, the fastening insert has a proximal end portion and a distal end portion in the first direction;
positioning the fastening insert in the traversing hole; and
plastically deforming a portion of the fastening insert to realize a form fit between the fastening insert and the body in the first direction and in a second direction opposite to the first direction.

12. The method of claim 11, wherein, in the plastically deforming step, the proximal end portion is deformed such that another form fit between the proximal end portion and the body is realized that blocks movement of the fastening insert in the first direction.

13. The method of claim 11, wherein the plastically deforming step includes increasing an extension of the proximal end portion in a direction orthogonal to the first direction.

14. The method of claim 13, wherein a cross-sectional area of the proximal end portion is increased in a plane orthogonal to the first direction.

15. The method of claim 11, wherein the plastically deforming step includes pressing a tool on the proximal end portion.

16. The method of claim 15, wherein the pressing of the tool is centered on the hollow and realized along the first direction.

17. The method of claim 16, wherein a tip of the tool has a shape of a cone having a vertex centered on the hollow.

18. A method of fastening an assembly part to a counterpart, comprising:
assembling an assembly part including a body traversed by a traversing hole and a fastening insert configured to receive a fastening device in a hollow of the fastening insert along a first direction to fasten the assembly part to the counterpart, the fastening insert has a proximal end portion and a distal end portion in the first direction, the fastening insert is positioned in the traversing hole, a movement of the fastening insert in a second direction opposite to the first direction is blocked by a first form fit between the distal end portion and the body, a movement of the fastening insert in the first direction is blocked by a second form fit between the proximal end portion and the body;
positioning the counterpart in contact with the assembly part, a through hole of the counterpart is centered on the traversing hole and faces one of the proximal end portion and the distal end portion of the fastening insert; and
mating the fastening device through the through hole with the fastening insert of the assembly part.

19. A fastening insert, comprising:
a hollow extending along a first direction; and
a proximal end portion, a middle portion, and a distal end portion in the first direction, the distal end portion has a ledge portion extending beyond a cross-section of the middle portion in at least one direction orthogonal to the first direction, the proximal end portion has a plastically deformable deformation portion.

20. The fastening insert of claim 19, wherein the plastically deformable deformation portion has an opening to the hollow and a bowl shape, the bowl shape has a center axis centered on the opening and opens outwardly in a second direction orthogonal to the first direction.

21. The fastening insert of claim 19, wherein an internal surface of the plastically deformable deformation portion has a shape of a frustum of a cone with a vertex centered on the hollow.

22. The fastening insert of claim 19, wherein the proximal end portion has a circumferential groove along an external surface of the fastening insert, the external surface corresponds to a border of the plastically deformable deformation portion.

23. The fastening insert of claim 22, wherein the circumferential groove extends in a plane orthogonal to the first direction.
